(19) United States
(12) Patent Application Publication
(10) Pub. No.: US 2025/0070388 A1
(43) Pub. Date: Feb. 27, 2025

(54) A SEPARATOR ELEMENT WITH A COATING COMPRISING NANOSTRUCTURES

(71) Applicant: Smoltek AB, GÖTEBORG (SE)

(72) Inventors: Qi Li, GÖTEBORG (SE); Fabian Wenger, GÖTEBORG (SE)

(21) Appl. No.: 18/722,675

(22) PCT Filed: Jan. 2, 2023
(86) PCT No.: PCT/EP2023/050015

§ 371 Date: Jun. 21, 2024

(30) Foreign Application Priority Data
Jan. 11, 2022 (SE) 2250014-4

(51) Int. Cl. H01M 50/449; H01M 50/403; H01M 50/431

(52) U.S. Cl. CPC H01M 50/449; H01M 50/403; H01M 50/431

(57) ABSTRACT

A separator element for an electrochemical cell, the separator element comprising a conductive substrate and a coating applied to the conductive substrate. The coating comprises a first part and a second part, wherein the first part comprises a basal layer extending along a surface of the conductive substrate and the second part comprises a plurality of nanostructures extending out from the surface of the conductive substrate.

### TECHNICAL FIELD

The present disclosure relates to electrochemical cells such as fuel cells and electrolyzers, and particularly to separator elements suitable for such cells.

### BACKGROUND

In modern energy systems, electrochemical cells such as batteries, fuel cells, and electrolyzers are seeing more and more wide-spread use. Electrolysis of water to form hydrogen gas is a promising technology for replacing the production of hydrogen gas from fossil fuels. It is also useful for energy storage, e.g. if excess electrical energy from intermittent energy sources such as solar and wind power can be used to power the electrolysis process. Meanwhile, fuel cells are used for the conversion of chemical energy to electrical energy for use e.g. in vehicles. Fuel cells are generally more efficient than internal combustion engines and some fuel cells can use sustainably produced hydrogen gas as fuel.

In existing electrochemical cells, high contact resistance between different components of the cell may lead to lower efficiency. This problem can be exacerbated by the formation of non-conducting surface layers on some components under the influence of the chemical environment of the cell. Additionally, corrosion of components such as bipolar plates or separator plates may in itself lead to lower efficiency and shorter cell lifetimes.

WO 2021/014144 A1 discloses a carbon-based coating for a separator element, intended to improve a resistance to corrosion.

WO 2019/186047 A1 discloses a separator element for an electrochemical cell with reduced contact resistance.

Still, separator elements showing lower contact resistance and better resistance to corrosion are needed.

### SUMMARY

It is an object of the present disclosure to provide improved separator elements for electrochemical cells, which, i.a., offer lowered contact resistance with adjacent components and an increased resistance to corrosion.

This object is at least in part obtained by a separator element for an electrochemical cell. The separator element comprises a conductive substrate and a coating applied to the conductive substrate. The coating comprises a first part and a second part, wherein the first part comprises a basal layer extending along a surface of the conductive substrate and the second part comprises a plurality of nanostructures extending out from the surface of the conductive substrate.

Advantageously, the basal layer comprised in the first part of the coating covers the surface of the conductive substrate, shielding it from the chemical environment of the electrochemical cell and reducing a risk of corrosion. Meanwhile, the plurality of nanostructures comprised in the second part of the coating reduce a contact resistance between the separator element and an adjacent component of the cell, such as a gas diffusion layer, by providing a large number of points of contact between the separator element and the adjacent component.

In particular, if the adjacent component has an uneven or porous surface comprising ridges, bumps, pits and/or grooves, the actual area of contact between an uncoated separator element and the adjacent component may be quite small as only the ridges and bumps make contact with the separator element surface. If the separator element has a coating comprising a plurality of nanostructures extending out from the surface of the separator element, these nanostructures make contact with additional parts of the surface of the adjacent component, thereby increasing the area of contact. This reduces the contact resistance between the separator element and the adjacent component.

According to aspects, the basal layer may comprise a carbon material. Advantageously, many carbon materials are known to have good electrical and thermal conductivity, which makes them suitable for use as separator element coatings and particularly for reducing contact resistance. Several carbon materials are also known to be chemically stable under the conditions found electrochemical cells, particularly in proton exchange membrane (PEM) fuel cells and on the cathode side in PEM electrolyzers. For example, the basal layer may comprise any of graphene, graphite, and amorphous carbon.

The plurality of nanostructures may comprise a plurality of carbon nanostructures. For example, the plurality of carbon nanostructures may comprise at least one carbon nanowall and/or any of a carbon nanotube, a carbon nanowire, and a carbon nanofiber. In addition to the aforementioned advantages of carbon materials in general, properties of these carbon nanostructures such as density and shape can be adjusted by altering the conditions under which the nanostructures are produced. Carbon nanowalls, nanofibers and nanowires are also mechanically rigid, making it easier to maintain a preferred orientation of the nanostructures relative to the surface of the conductive substrate.

Carbon nanowalls, also known as vertical graphene, have the further advantage that they can be grown without the use of a growth catalyst. In particular, a combination of a basal layer comprising carbon and a plurality of carbon nanowalls can be grown without a growth catalyst and in a single production step, which is efficient and lowers production costs.

The nanostructures comprised in the plurality of nanostructures may extend in parallel to each other along a direction perpendicular to a plane of extension of the conductive substrate. This largely uniform orientation of the nanostructures facilitates the formation of additional points of contact with an adjacent component such as a gas diffusion layer.

Optionally, the conductive substrate comprises a flow field arrangement. The flow field arrangement comprises a plurality of flow channels separated by a plurality of channel supports. The flow channels are arranged to promote an even distribution of a gas and/or liquid over the conductive substrate. Advantageously, an even distribution of gas and/or liquid across the flow field arrangement leads to an even distribution of the reactants and products of the electrochemical reaction in the electrochemical cell, leading to a more efficient use of the whole area of the cell.

Due to the harsh chemical environment in electrochemical cells, resulting e.g. from high or low pH and high electrical potentials, materials forming components of the electrochemical cell may be at risk of corrosion. Therefore, the separator element may be at least partly covered by a protective layer arranged to increase a resistance to corrosion. The protective layer may for example comprise any of titanium, gold, and platinum.

There is also herein disclosed an electrolyzer comprising at least one separator element as described above. Advantageously, the coating comprised in the separator element reduces the contact resistance between the separator element and adjacent components such as gas diffusion layers, thereby increasing the efficiency of the electrolyzer.

Furthermore, there is herein disclosed a fuel cell comprising at least one separator element as described above. As with the electrolyzer, the efficiency of the fuel cell is increased due to the lowered contact resistance between the separator element and adjacent components such as gas diffusion layers.

The object is also obtained at least in part by a method for producing a separator element comprising a conductive substrate and a coating applied to the conductive substrate. The method comprises arranging the conductive substrate and depositing a first part of the coating onto the conductive substrate, wherein the first part comprises a basal layer extending along a surface of the conductive substrate. The method further comprises depositing a second part of the coating onto the conductive substrate, wherein the second part comprises a plurality of nanostructures extending out from the surface of the conductive substrate.

Advantageously, the basal layer comprised in the first part of the coating protects the surface of the conductive substrate, thereby shielding it from the chemical environment of the electrochemical cell and reducing a risk of corrosion. Meanwhile, the plurality of nanostructures comprised in the second part of the coating reduce a contact resistance between the separator element and an adjacent component of the cell, such as a gas diffusion layer, by providing a large number of points of contact between the separator element and the adjacent component.

According to aspects, depositing the first part of the coating may comprise growing the basal layer using chemical vapor deposition. Growing the basal layer using chemical vapor deposition has the advantage that the structure and thickness of the basal layer can be controlled to achieve a desired result, such as a high degree of coverage of the substrate surface or a desired thickness of the basal layer.

Growing the basal layer using chemical vapor deposition may comprise adjusting a growth parameter to achieve a desired layer thickness. The growth parameter may for example be any of a substrate temperature, a plasma power, a partial pressure of a precursor gas, or a total pressure in a growth chamber. Advantageously, adjusting the growth parameters presents a straightforward means of controlling the basal layer thickness.

According to aspects, depositing the second part of the coating may comprise growing the plurality of nanostructures on the basal layer using chemical vapor deposition. Growing the plurality of nanostructures using chemical vapor deposition makes it possible to control parameters such as the type of nanostructure, the number of nanostructures per unit area of the substrate, and the nanostructure size and shape. In particular, growing the plurality of nanostructures using chemical vapor deposition may comprise adjusting a growth parameter to achieve a desired nanostructure morphology. The growth parameter may for example be any of a substrate temperature, a plasma power, a partial pressure of a precursor gas, or a total pressure in a growth chamber. This means that the nanostructures can be tailored to achieve a larger reduction of the contact resistance between the separator element and an adjacent component, which is an advantage.

Growing the plurality of nanostructures using chemical vapor deposition may comprise growing a plurality of nanostructures of different types, such as nanowalls, nanotubes, nanowires, or nanofibers. An advantage of having a plurality of nanostructures of different types is that a combination of different types of nanostructures offers more possibilities of tailoring the overall structure to achieve a desired result such as covering a certain fraction of the substrate surface or producing nanostructures of a desired height or mechanical stiffness. Growing a plurality of nanostructures of different types may comprise adjusting a growth parameter to grow different nanostructure types.

A particular advantage can be achieved by growing a basal layer comprising a carbon material such as graphene, graphite, or amorphous carbon, and a plurality of nanostructures comprising carbon nanowalls, also known as vertical graphene. This combination of a carbon basal layer and carbon nanowalls can be grown without the use of a growth catalyst, thereby lowering the production cost.

The method may also comprise depositing a growth catalyst layer on the conductive substrate and growing the basal layer and/or the plurality of nanostructures on top of the growth catalyst layer. Growing some types of nanostructures may require the use of a growth catalyst to facilitate the chemical reactions involved in the nanostructure growth. Using a growth catalyst layer makes it possible to include these types of nanostructures in the coating, which is an advantage.

The methods disclosed herein are associated with the same advantages as discussed above in connection to the different apparatuses.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where:

FIG. 1 schematically illustrates a fuel cell;

FIG. 2 schematically illustrates an electrolyzer;

FIG. 3 schematically illustrates a separator element;

FIGS. 4A and B schematically illustrates a separator element arrangement;

FIG. 5 schematically illustrates a cross-section of carbon nanowalls;

FIGS. 6A and B schematically illustrates a flow field arrangement;

FIG. 7 is a scanning electron microscope (SEM) image of carbon nanostructures; and

FIG. 8 is a flow chart illustrating methods.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

The following description is focused on two types of electrochemical cells, namely fuel cells and electrolyzers. In particular, it deals with fuel cells and electrolyzers that comprise a proton exchange membrane and use hydrogen gas as a fuel or produce hydrogen gas from water, respectively. However, a person skilled in the art will realize that the devices and methods herein described can also be used in other types of electrochemical cells such as batteries or supercapacitors.

The disclosure is also applicable to other types of fuel cells and electrolyzers than the ones described in detail herein, e.g., fuel cells that use methanol as a fuel or electrolyzers using an alkaline electrolyte. In particular, the disclosure is applicable to fuel cells and electrolyzers wherein another type of solid electrolyte, such as an anion exchange membrane, is used in place of a proton exchange membrane.

In a fuel cell, chemical energy from a fuel is converted into electrical energy through reduction and oxidation reactions. A fuel cell comprises two electrodes, and an electrolyte that allows ions to travel between the electrodes. The electrodes are also electrically connected to an electric load, where the generated electrical energy is used.

The fuel cell electrolyte must simultaneously be a good ionic conductor, i.e., be able to transport ions, and a poor electronic conductor, i.e., hinder the transport of electrons. Fuel cell electrolytes may be liquids, such as liquid solutions of alkaline salts or molten carbonate compounds, or solids such as polymer membranes or metal oxides. Examples of polymer membrane materials are sulfonated tetrafluoroethylene, also known as Nafion, and polymers based on polysulfone or polyphenole oxide. lon-conducting metal oxides may be e.g., doped barium zirconate, doped barium cerate, doped lanthanum gallate, or stabilized zirconia. Different electrolytes may be suitable for conducting different types of ions. For example, sulfonated tetrafluoroethylene-based membranes such as Nafion can conduct hydrogen ions, i.e., protons, and are therefore known as proton exchange membranes or PEM. Many metal oxides are suitable for conducting oxygen ions.

Preferably, the electrolyte should also hinder transport of the fuel from one electrode to the other through the electrolyte. If the electrolyte membrane is made of a material that is too permeable to the fuel, another material may be added to the membrane in order to hinder the fuel transport. As an example, in methanol fuel cells comprising a Nafion membrane, ruthenium may be added on one side of the membrane.

Fuel cells that use ion exchange membranes such as Nafion are often referred to as proton exchange membrane fuel cells or PEMFC, since the membrane conducts protons. In PEMFC, a hydrogen-containing fuel such as hydrogen gas is introduced at the first electrode, known as the anode, while an oxygen-containing gas is introduced at the second electrode, known as the cathode. At the anode, the hydrogen is split into protons and electrons with the aid of an electrocatalyst. This is referred to as the hydrogen oxidation reaction. The protons traverse the ion exchange membrane to the cathode, while electrons traverse the electrical connection between the anode and the cathode, where the generated electrical energy can be put to use. At the cathode, protons and electrons react with oxygen through the oxygen reduction reaction to form water. This reaction is also aided by an electrocatalyst.

A catalyst is a material or chemical compound that facilitates a chemical reaction, e.g., by lowering the amount of energy needed for the chemical reaction. An electrocatalyst is a catalyst used in an electrochemical reaction such as the hydrogen oxidation and oxygen reduction reactions taking place in a fuel cell. Fuel cell electrocatalysts frequently comprise noble metals such as platinum, ruthenium, or palladium.

In PEMFC and other fuel cells using solid ion conductors, the anode and cathode catalysts are often arranged as electrocatalyst layers on opposite surfaces of the ion exchange membrane. For PEMFC in particular, the electrocatalyst layers often comprise an electrocatalyst material such as platinum in the form of nanoparticles, that is, particles with a diameter that is substantially smaller than one micrometer and mostly between 1 and 100 nm. The electrocatalyst layer typically also comprises a catalyst binder or support, often comprising carbon nanomaterials such as carbon nanoparticles or nanotubes, or carbon black. The electrocatalyst layer may also comprise an ionically conductive polymer, arranged to facilitate transport of hydrogen ions to the ion exchange membrane, and hydrophobic materials such as polytetrafluoroethylene. According to aspects, a catalyst layer may be between 5 and 50 nm thick. According to other aspects, the thickness of the catalyst layer may depend on the type of catalyst used.

An ion exchange membrane with an anode electrocatalyst layer and a cathode electrocatalyst layer arranged on opposite surfaces is sometimes referred to as a membrane electrode assembly.

In order for the fuel cell to operate, ions and electrons must be able to travel from the anode-side electrocatalyst, through the ion exchange membrane and the electric load respectively and reach the cathode-side electrocatalyst. In addition, reactant gases such as hydrogen and oxygen gas must be able to reach the electrocatalyst layers, while the product, water vapor, must be continually removed from the cell. In most PEMFC, this is accomplished by arranging an electrically conductive porous material in a layer next to each catalyst layer, and an electrically conductive separator element next to the layer of porous material.

The layer of porous material may for example be referred to as a porous transport layer (PTL), mass transport layer, gas diffusion layer (GDL), or just diffusion layer. Some of these terms, e.g. gas diffusion layers, are commonly used in the context of fuel cells, while some terms such as porous transport layers are more commonly used in the context of electrolyzers. However, they all refer to layers of porous material performing the function of simultaneously allowing both electron transport and mass transport of products and reactants to and from an active layer such as an electrocatalyst layer. Therefore, the different terms mentioned above will be used interchangeably in this disclosure, both in the context of fuel cells and in the context of electrolyzers.

A conductive material, element, or component is here taken to be a material, element, or component that has a high electric conductivity. A high electric conductivity could be an electric conductivity normally associated with metallic or semiconducting materials, or an electric conductivity of more than 100 Sm⁻¹.

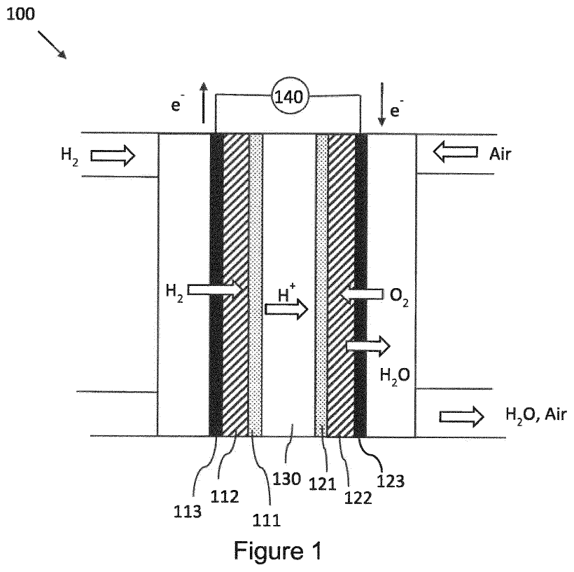

FIG. 1 shows a fuel cell 100 comprising an ion exchange membrane 130, a first electrocatalyst layer 111 and a second electrocatalyst layer 121. The first and second electrocatalyst layers 111, 121 are arranged adjacent to the ion exchange membrane on either side of the ion exchange membrane. A first GDL 112 and a second GDL 122 are arranged adjacent to the respective first and second electrocatalyst layers 111, 121 on the side of the electrocatalyst layer facing away from the ion exchange membrane 130. Adjacent to the first and second GDLs 112, 122, on the side facing away from the respective electrocatalyst layer 111, 121, there is a respective first and second separator element 113, 123. Each separator element is electrically connected to the load 140.

The GDLs 112, 122, are arranged to allow reactants and products such as hydrogen gas, oxygen gas, and water to be transported through the pores of the GDL, while still maintaining electrical contact between the electrocatalyst layer and the separator element. GDLs often comprise porous electrically conductive materials such as metal foams, porous carbon, or carbon paper. The GDLs may also provide structural support for the electrocatalyst layers 111, 121 and ion exchange membrane 130.

The separator elements 113, 123 often comprise metallic materials such as steel, titanium, and/or other electrically conductive materials such as carbon composites. The separator elements 113, 123 are connected to the electrical load, and also separate the fuel cell from its surroundings. If the fuel cell forms part of a fuel cell stack, a separator element may form part of the cathode side of one fuel cell and the anode side of an adjacent fuel cell, in which case it may be referred to as a bipolar plate. Other possible terms used to denote the separator element are separator plate, separator element, or flow plate.

As previously mentioned, the present disclosure also relates to electrolyzers. Water electrolyzers use electrical energy to split water into oxygen gas and hydrogen gas. Electrolyzers normally comprise similar components as described above for fuel cells. In particular, they comprise an ion-conducting electrolyte and two electrodes, one of which is a cathode and the other of which is an anode. The cathode and anode are electrically connected to a power source. Proton exchange membranes such as Nafion can be used as electrolytes in electrolyzers as well as in fuel cells, as can the other abovementioned polymer membranes and solid oxide ionic conductors. Liquid electrolytes comprising an alkaline solution may also be used.

In an electrolyzer comprising a proton-conducting electrolyte such as a PEM, water will be introduced at the anode side and split into oxygen and hydrogen in what is known as the oxygen evolution reaction. The oxygen will form oxygen gas while the hydrogen is split into protons, which will subsequently traverse the ion exchange membrane and reach the cathode, and electrons which travel to the cathode via the power source. At the cathode protons and electrons form hydrogen gas through the hydrogen evolution reaction.

The electrocatalysts used in electrolyzers may differ from those used in fuel cells. In electrolyzers using PEM electrolytes, the anode-side electrocatalyst often comprises iridium oxide, while the cathode-side electrocatalyst generally comprises platinum or other platinum-group metals. In electrolyzers using an anion exchange membrane, AEM, electrolyte, both electrocatalysts may instead comprise materials such as nickel or cobalt.

In electrolyzers that comprise solid electrolytes such as PEM and AEM the anode and cathode electrocatalysts are often arranged in electrocatalyst layers on opposite sides of the electrolyte membrane to form a membrane electrode assembly, as previously described for fuel cells. One or both electrocatalysts may be in the form of nanoparticles. In addition to the electrocatalyst itself, the electrocatalyst layer may comprise a catalyst support such as carbon black, carbon nanotubes, or a metal foam. The electrocatalyst layer may also comprise an ionically conducting polymer and hydrophobic materials such as Teflon.

The requirements on ion transport through the electrolyte, mass transport of reactants and products to and from the electrocatalyst, and good electrical contact between the elements in the cell are similar in an electrolyzer as in a fuel cell. Therefore, electrolyzers are also often equipped with porous transport layers arranged adjacent to each electrocatalyst layer and separator elements arranged adjacent to each diffusion layer. The diffusion layers may comprise porous carbon materials, metal foams, or metal meshes, often comprising titanium. The separator elements may for example comprise metallic materials such as steel or titanium, or electrically conducting carbon composites.

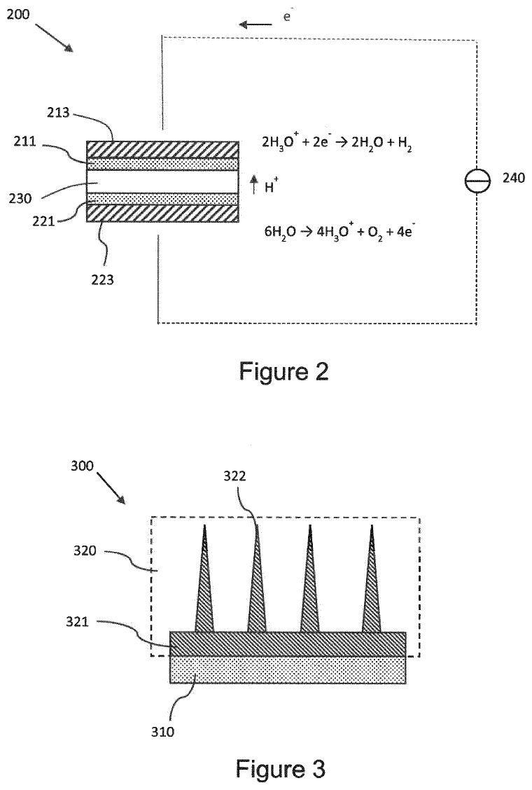

FIG. 2 shows an electrolyzer 200 comprising an ion exchange membrane 230, a first electrocatalyst layer 211 and a second electrocatalyst layer 221. The first and second electrocatalyst layers are arranged adjacent to the ion exchange membrane 230 on either side of the ion exchange membrane. A first porous transport layer 212 and a second porous transport layer 222 are arranged adjacent to the first and second electrocatalyst layer on the side of the electrocatalyst layer facing away from the ion exchange membrane 230. Adjacent to the first and second porous transport layer 212, 222, on the side facing away from the respective electrocatalyst layer, are arranged a respective first and second separator element 213, 223. Both separator elements are connected to a power source 240.

In both fuel cells and electrolyzers, it is important to minimize the electrical contact resistance between the separator element and the gas diffusion layer/porous transport layer and to prevent corrosion of the components in order to maintain efficient operation. However, higher contact resistance sometimes develops between a separator element and the adjacent gas diffusion layer, for example as a result of insufficient physical contact between the two components. The issue may be exacerbated by the formation of compounds that are not electrically conductive, such as metal oxides, on the surface of the separator element.

To mitigate issues related to contact resistance and corrosion, a coating can be applied to the surface of the separator element. FIG. 3 shows a separator element 300 for an electrochemical cell, where the separator element 300 comprises a conductive substrate 310 and a coating 320 applied to the conductive substrate. The coating comprises a first part and a second part, wherein the first part comprises a basal layer 321 extending along a surface of the conductive substrate 310. The second part comprises a plurality of nanostructures 322 extending out from the surface of the conductive substrate 310.

Typically, the conductive substrate 310 is a planar element or plate comprising a metallic element such as stainless steel or titanium. A planar element is extended in two dimensions and comparatively thin in the third dimension. The two dimensions in which such an element is extended define a plane of extension of the element.

Each planar element generally comprises two large bounding surfaces that are mostly parallel to the plane of extension, and that are typically the largest bounding surfaces of the element. These bounding surfaces can be referred to as a first and second side of the planar element. In an electrochemical cell, at least one side of the conductive substrate will be facing a gas diffusion layer or GDL. The GDL may also be a planar element, in which case the first side of the conductive substrate 310 can be said to be facing a first side of the GDL.

The GDL generally comprises porous materials such as carbon paper, carbon felt, or porous metallic materials. The surface of the GDL will therefore be uneven and may comprise e.g. pits, bumps, ridges, and grooves. When the GDL is pressed against the separator element, it may be that only the bumps and ridges make contact with the surface of the separator element. This means that the actual surface area over which the separator element and GDL are in contact is relatively small compared to the total surface area of the separator element, leading to a higher contact resistance. It should be noted that the conductive substrate 310 may also have an uneven surface, which may contribute to this issue.

The coating 320 applied to the conductive substrate 310 is arranged to mitigate this problem. The first part of the coating, comprising the basal layer 321, covers a large fraction of the surface of the side of the conductive substrate 310 facing the GDL. For example, the basal layer 321 may cover more than 90% of the surface. Preferably, the basal layer 321 covers 100% of the surface.

It should be noted that if the separator element 300 is a bipolar plate separating two neighboring electrochemical cells, there may be a first GDL facing the first side of the conductive substrate 310 and a second GDL facing the second side of the conductive substrate 310. In this case, the coating 320 may cover both the first and second side of the conductive substrate 310, as both the first and second side are facing gas diffusion layers.

The second part of the coating comprises a plurality of nanostructures 322. The nanostructures comprised in the plurality of nanostructures 322 may be arranged to increase the fraction of the substrate covered by the coating 320. As an example, if the basal layer 321 covers 90% of the surface, some of the nanostructures in the plurality of nanostructures 322 may cover the remaining 10%. For efficient corrosion protection, it is an advantage to have the coating 320 cover as large a fraction as possible of the surface of the conductive substrate 310.

A nanostructure is a structure having a size that is substantially smaller than one micrometer, and preferably between 1 and 100 nm, in at least one dimension. The plurality of nanostructures 322 may comprise largely planar nanostructures that are substantially smaller in one dimension, denoted here as the thickness, than in the two others which are denoted here as length and height. Substantially smaller may e.g. mean that the thickness is less than 20% of the length or height. Such nanostructures may be called nanowalls or nanosheets.

That a nanostructure is largely planar should not be taken to mean that it is perfectly flat but could also mean that the nanostructure is e.g. concave, convex, uneven, or undulating, as long as it is extended along two dimensions and significantly smaller along the third.

Relative to the surface of the conductive substrate 310, the length of a planar nanostructure is herein considered to be the dimension that extends along the surface of the conductive substrate 310, while the height is the dimension extending out from the surface of the conductive substrate 310.

The plurality of nanostructures 322 may also comprise elongated nanostructures that are substantially larger in one dimension, denoted here as the height, than in the two others. As an example, consider a substantially cylindrical nanostructure characterized by a height and a diameter. The nanostructure may be considered elongated if the height is significantly larger than the diameter, e.g., if the height is more than twice as large as the diameter. Similar reasoning may be applied to nanostructures that are substantially conical, frustoconical, rectangular, or of arbitrary shape.

Elongated nanostructures may for example be straight, spiraling, branched, wavy or tilted. Optionally, they are classifiable as nanowires, nano-horns, nanotubes, nano-walls, crystalline nanostructures, or amorphous nanostructures.

The nanostructures comprised in the plurality of nanostructures 322 can be considered as extending in a direction out from the surface of the conductive substrate 310. This extension direction is along what is herein denoted the height dimension of the nanostructure. That a nanostructure extends out from the surface of the conductive substrate is taken to mean that the extension direction forms an angle with the plane of extension of the conductive substrate and that the angle is at least 30 degrees, preferably more than 45 degrees. Optionally, the angle may be around 90 degrees.

By extending out from the surface of the conductive substrate, the plurality of nanostructures 322 provide an increased number of points at which the GDL can come into physical contact with the separator element 300. This increases the total surface area over which the separator element in contact with the GDL, which in turn decreases the contact resistance between the two components.

Thus, the plurality of nanostructures increases the mechanical contact between the separator element 300 and the GDL. The increased mechanical contact leads to improved electrical contact and reduced contact resistance, particularly if the nanostructures comprise an electrically conductive material. In this case, the physical contact between the nanostructures and the GDL also establishes an electrical connection.

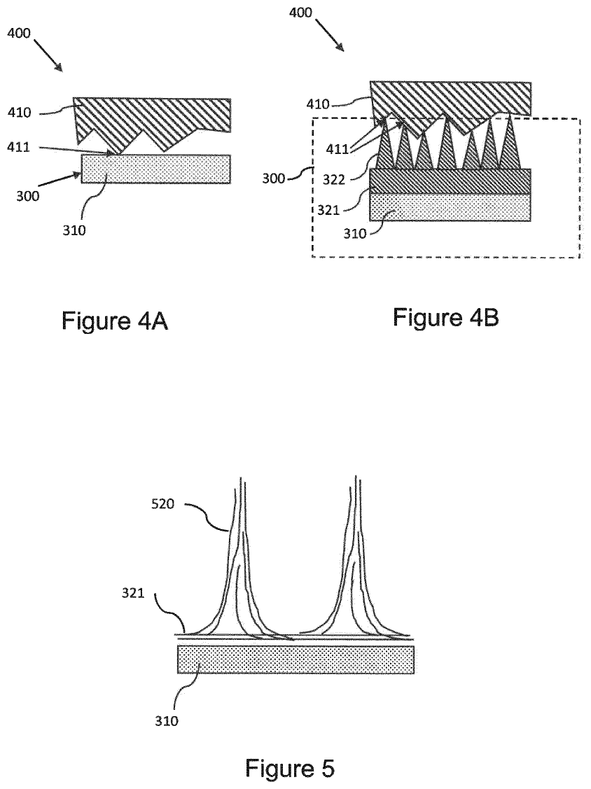

FIGS. 4A and 4B show a separator element arrangement 400 comprising a separator element 300 and a porous gas diffusion layer 410 comprising an uneven surface. The separator element 300 and the gas diffusion layer are arranged adjacent to each other. FIG. 4A shows a separator element 300 comprising an uncoated conductive substrate 310, which only comes into contact with the gas diffusion layer 410 at a small number of points 411 due to the uneven surface of the gas diffusion layer 410. FIG. 4B shows a separator element 300 comprising a conductive substrate 310 with a basal layer 321 and a plurality of nanostructures 322, the nanostructures increasing the number of points 411 where the gas diffusion layer 410 and the separator element are in contact as described above.

According to some aspects, the extension directions of different nanostructures comprised in the plurality of nanostructures may have different angles to the plane of extension of the conductive substrate, so that different nanostructures extend in different directions from the surface. According to other aspects and with reference to FIG. 3, the nanostructures comprised in the plurality of nanostructures extend in parallel to each other along a direction perpendicular to a plane of extension of the conductive substrate 310.

In order to provide an increased number of contact points between the GDL and the separator element, it is advantageous to have the nanostructures oriented in a uniform direction. This should not be taken to mean that the nanostructures are completely straight or completely perpendicular to the plane of extension of the conductive substrate 310. The nanostructures may extend generally along a direction perpendicular to the plane of extension, which can be taken to mean that the nanostructures may have a moderate tilt relative to the normal vector of the plane of extension, or they may curve back and forth to form a spiraling or wavy shape. In this context, a moderate tilt may mean that the angle between the extension direction of the nanostructures and the plane of extension is more than 60 degrees, and preferably more than 80 degrees.

The basal layer 321 is preferably arranged to shield the conductive substrate from the chemical environment of the cell, thereby increasing its resistance to corrosion, while also maintaining good electrical conductivity. The basal layer 321 thus preferably comprises materials with a high electrical conductivity and good chemical stability under the conditions of the electrochemical cell. The basal layer may comprise metals such as titanium, platinum, or gold, or compounds such as titanium nitride. Preferably, the basal layer 321 comprises a carbon material.

Carbon materials are frequently used in electrochemical cells due to their good electrical conductivity and chemical stability. In particular, carbon materials are used on both the anode and the cathode side in fuel cells and on the cathode side in electrolyzers. According to aspects, the basal layer 321 comprises any of graphene, graphite, and amorphous carbon. The basal layer 321 may also comprise graphene foam or graphite foam.

Preferably, the nanostructures comprised in the plurality of nanostructures 322 comprise an electrically conductive material such as any of metal, a metal alloy, a semiconductor, and an electrically conductive metal oxide. In particular, the plurality of nanostructures 322 may comprise a plurality of carbon nanostructures. Like the previously mentioned carbon materials, carbon nanostructures have high electrical conductivity and good chemical stability. In addition, the shape and structure of carbon nanostructures can be altered by adjusting the conditions under which the nanostructures are grown, so as to obtain e.g. a desired density or shape of the nanostructures, a desired size of the nanostructures or a desired number of nanostructures per surface area.

The shape and structure of elongated carbon nanostructures can be altered by adjusting the conditions under which the nanostructures are grown, such as temperature and pressure, in order to obtain e.g., a desired density or shape of the nanostructures, a desired size of the nanostructures or a desired number of nanostructures per surface area. Due to their chemical stability, carbon nanostructures also have the advantage that non-conductive compounds are unlikely to form on the surface, which is advantageous for maintaining a low electrical contact resistance. This is especially an advantage compared to metallic material such as steel or titanium, which may form a non-conductive metal oxide layer on the surface. The plurality of carbon nanostructures 322 may comprise at least one carbon nanowall. A carbon nanowall, which can also be known as a carbon nanosheet or vertical graphene, comprises at least one graphene layer protruding at an angle from the surface on which the nanostructure grown. The angle may be more than 80 degrees, i.e., the vertical graphene may protrude along a direction that is close to perpendicular to the plane of extension from the surface on which it is grown.

Graphene has a high electrical conductivity and high thermal conductivity, which makes it suitable for forming part of the coating 320 of the separator element 300. Vertical graphene in particular presents a large surface area with many possible contact points between the graphene and the GDL, which is advantageous for reducing contact resistance.

If the basal layer 321 comprises carbon materials such as amorphous carbon, graphene, or graphite, vertical graphene nanostructures may be formed in one piece with the basal layer by growing both the basal layer and the vertical graphene on the conductive substrate. The graphene sheets in the vertical graphene and the carbon comprised in the basal layer 321 will then join at the base of the vertical graphene, which allows the coating 320 as a whole to cover the surface of the conductive substrate with a reduced number of holes or gaps. This is schematically illustrated in FIG. 5, which shows the structure of two carbon nanowalls in cross-section. The carbon nanowalls 510 are shown extending upwards from the basal layer and joined to the basal layer.

Additionally, growing a carbon basal layer 321 and a plurality of nanostructures 322 comprising vertical graphene on the conductive substrate may be accomplished without the use of special catalysts. FIG. 7 shows a SEM image of carbon nanowalls or vertical graphene grown on a substrate.

Again with reference to FIG. 3, the plurality of carbon nanostructures may comprise any of a carbon nanotube, a carbon nanowire, and a carbon nanofiber. Carbon nanofibers and nanowires have the advantage of a high stiffness and rigidity, making them less likely to be deformed if the electrochemical cell is assembled by a method such as pressing the components together, and more likely to remain in a desired orientation relative to the conductive substrate 310. Carbon nanotubes, carbon nanowires, and carbon nanofibers may as an example be comprised in the plurality of carbon nanostructures separately, in combination, and/or in combination with vertical graphene. Advantageously, carbon nanotubes, carbon nanofibers, and carbon nanowires can also be grown on the conductive substrate along with a basal layer comprising carbon and vertical graphene nanostructures. If the plurality of carbon nanostructures comprises several types of carbon nanostructure, such as a combination of carbon nanofibers and vertical graphene, the properties of the different nanostructures can be used e.g. to maximize surface area or increase the fraction of the surface of the conductive substrate 310 that is covered by the coating 320.

The shape and structure of carbon nanostructures can be altered by adjusting the conditions under which the nanostructures are grown, so as to obtain e.g., a desired density or shape of the nanostructures, a desired size of the nanostructures or a desired number of nanostructures per surface area.

Separator elements used in electrochemical cells often comprise flow field arrangements that are used to promote an even distribution of reactants across the separator element, as well as facilitating the removal of reaction products. An even or uniform distribution is herein taken to mean that the concentration of the reactants is similar across the flow field arrangement. Thus, the flow field arrangement is arranged to promote an even distribution of the reactants if it contributes to a more uniform concentration of the reactants across the separator element surface compared to a separator element without a flow field arrangement.

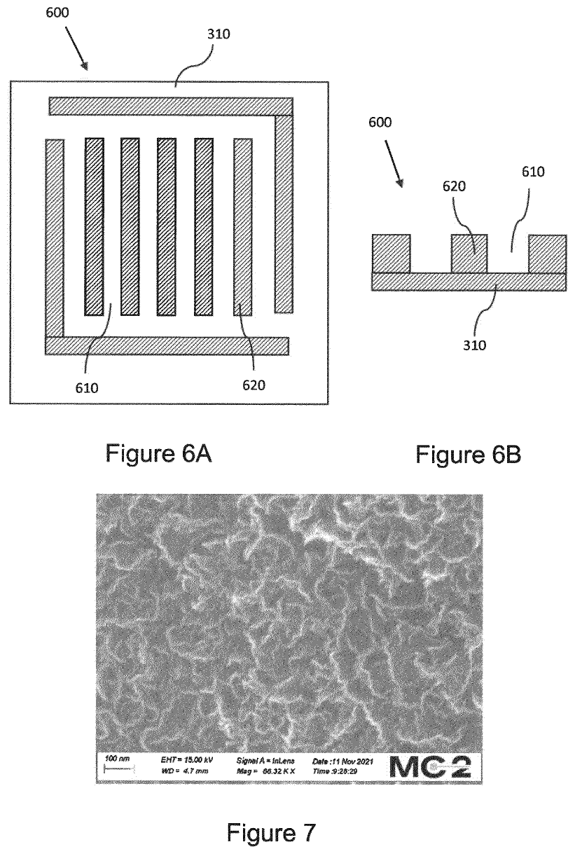

A schematic of an example flow field arrangement is shown in FIGS. 6A and B. The flow field arrangement 600 comprises a plurality of grooves, known as flow channels 610, separated by ridges known as ribs or channel supports 620. Gases and liquids can flow along the flow channels 610 and thus be spread out over the entire separator element. As an example, the flow field arrangement may be formed by creating indentations in the conductive substrate 310 of the separator element to form the flow channels 610. As another example, the flow field arrangement may be formed by depositing a material on the surface of the conductive substrate 310 to form the channel supports 620.

When the separator element is a planar element, the flow field arrangement is generally arranged on the first and second sides described above, that is, on the surfaces of the element that are parallel with the plane of extension of the element. In the separator element arrangement as described herein, the flow field may be arranged on the surface of the separator element facing the GDL. If the separator element is a bipolar plate used in a stack of electrochemical cells, two flow field arrangements may be arranged on opposite sides of the separator element.

The type of flow field arrangement 600 shown in FIGS. 6A and 6B is known as a straight parallel flow field arrangement, due to the placement of the ribs promoting a parallel flow of gases and/or liquids through neighboring channels. Other flow field arrangement designs may also be used, such as serpentine, interdigitated, or pin-type flow field arrangements.

Accordingly, the conductive substrate 310 may comprise a flow field arrangement 600, the flow field arrangement comprising a plurality of flow channels 610 separated by a plurality of channel supports 620, wherein the flow channels are arranged to promote an even or uniform distribution of a gas and/or liquid over the conductive substrate. That is, the flow channels are arranged to contribute to a more uniform concentration of gases and liquids across the flow field arrangement.

The chemical environment in an electrochemical cell can cause corrosion and/or degradation of some materials. Although carbon materials are generally sufficiently chemically stable for use in fuel cells and on the cathode side in electrolyzers, they may require additional surface treatment for use e.g., on the anode side in electrolyzers. Other materials used in separator elements, such as stainless steel, may also require additional treatment in order to tolerate the environment in the electrochemical cell. Thus, the separator element may be at least partly covered by a protective layer arranged to increase a resistance to corrosion. The protective layer may comprise any of titanium, gold, and platinum, or a combination thereof. The protective coating may also comprise titanium nitride, ceramic materials or metal oxides such as aluminum oxide, cerium oxide and zirconium oxide. The protective coating may also comprise carbon-based materials. The protective coating may cover at least part of the coating 320. The protective coating may also cover a surface of the conductive substrate 310 that are not covered by the coating 320, such as an opposite side or an edge of the conductive substrate 310.

There is also herein disclosed an electrolyzer 100 comprising at least one separator element 300 as previously described, as well as a fuel cell 200 comprising at least one separator element 300 as previously described.

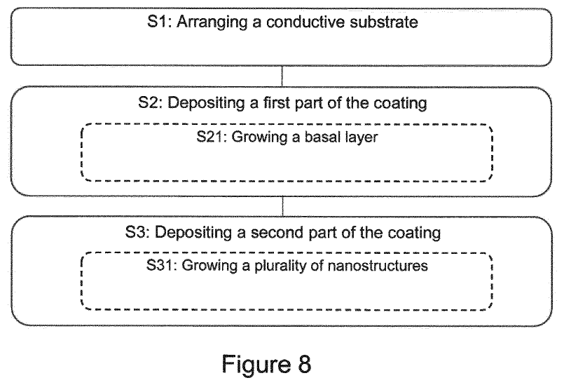

FIG. 8 presents a method for producing a separator element 300, where the separator element comprises a conductive substrate 310 and a coating 320 applied to the conductive substrate. The method comprises arranging S1 the conductive substrate 310 and depositing S2 a first part of the coating 320 onto the conductive substrate 310. The first part of the coating 320 comprises a basal layer 321 extending along a surface of the conductive substrate. The method also comprises depositing S3 a second part of the coating 320 onto the conductive substrate 310, where the second part comprises a plurality of nanostructures 322 extending out from the surface of the conductive substrate.

The conductive substrate may comprise materials such as stainless steel or titanium. The first and second part of the coating may comprise materials such as metals, metal alloys, semiconductors, or metal oxide. The first and second part of the coating may also comprise carbon materials.

A basal layer 321 may be deposited using methods such as evaporating, plating, sputtering, molecular beam epitaxy, pulsed laser depositing, spin-coating, spray-coating, or other suitable methods. The deposition method may be selected in dependence of the materials comprised in the basal layer 321.

A plurality of nanostructures 322 may be generated through lithographic methods such as colloidal lithography or nanosphere lithography, focused ion beam machining and laser machining. Nanostructures comprising carbon or organic compounds may be generated using methods such as electrospinning or chlorination of carbides or metalloorganic compounds such as titanium carbide and ferrocene. The generated nanostructures could then be deposited onto the conductive substrate 310 or the basal layer 321.

Preferably, chemical vapor deposition (CVD) methods can be used to deposit the first and/or second part of the coating. In general, the CVD process comprises exposing a substrate to a precursor gas, which subsequently undergoes a reaction on the surface of the substrate to produce the desired structure. The formation of the structure may be aided by factors such as the substrate temperature, the pressure in the growth chamber, the presence of other gases such as inert carrier gases or reducing gases, and the presence of a growth catalyst.

Examples of CVD methods include rapid thermal CVD, hot filament CVD, laser CVD, combustion CVD and plasma-enhanced CVD. Plasma-enhanced CVD or PECVD further includes methods such as capacitively coupled plasma PECVD, inductively coupled plasma PECVD, radio-frequency plasma PECVD, DC plasma CVD, and microwave plasma PECVD.

According to aspects, depositing S2 the first part of the coating may comprise growing S21 the basal layer 321 using chemical vapor deposition. Optionally, the basal layer 321 may be deposited using hot filament CVD or rapid thermal CVD.

The basal layer 321 may also be deposited using PECVD. According to one example, the basal layer 321 may be deposited using a low plasma power, e.g., a plasma power between 5 and 50 W. According to another example, the plasma power may be adjusted to result in a basal layer with desirable properties, such as high density or a desired structure.

The growth of the basal layer 321 using CVD is controlled by a number of growth parameters, such as temperature, pressure, and which gases are used as precursor, reducing, and inert carrier gases, as well as the relative concentration of the precursor, reducing, and inert carrier gases. In the case of PECVD, the plasma power and the type of plasma, such as RF plasma or DC plasma, are also growth parameters. These growth parameters influence properties of the basal layer 321 such as thickness and structure. Accordingly, growing the basal layer 321 using chemical vapor deposition may comprise adjusting one or several of these growth parameters to achieve a desired layer thickness.

According to other aspects, depositing S3 the second part of the coating comprises growing S31 the plurality of nanostructures 322 on the basal layer 321 using chemical vapor deposition. Preferably, the plurality of nanostructures 322 may be grown using PECVD.

Similarly to growing the basal layer 321, the properties of the resulting plurality of nanostructures grown by CVD depends on growth parameters such as temperature, pressure, and which gases are used as precursor, reducing, and inert carrier gases, as well as the relative concentration of the precursor, reducing, and inert carrier gases. In the case of PECVD, the plasma power and the type of plasma, such as RF plasma or DC plasma, are also growth parameters. Growing S31 the plurality of nanostructures 322 using chemical vapor deposition may comprise adjusting one or several of these growth parameters to achieve a desired nanostructure morphology.

The plurality of nanostructures may comprise only one type of nanostructure, such as nanowalls, nanotubes, nanowires, or nanofibers. The plurality of nanostructures may also comprise a combination of different types of nanostructures, e.g. both nanowalls and nanofibers. Accordingly, growing S31 the plurality of nanostructures 322 using chemical vapor deposition may comprise growing a plurality of nanostructures of different types, such as nanowalls, nanotubes, nanowires, or nanofibers. Growing a plurality of nanostructures 322 of different types may be achieved by adjusting a growth parameter such as temperature, pressure, or plasma power to grow different nanostructure types. Other parameters that can be adjusted are which gases are used as precursor, reducing, and inert filler gases, as well as the relative concentration of the precursor, reducing, and inert filler gases. The type of plasma, such as RF plasma or DC plasma, can also be changed to affect the growth result.

If different types of nanostructures are grown in sequence, this may be used to increase the fraction of the surface of the conductive substrate 310 that is covered with nanostructures. As an example, if a plurality of nanowalls is grown first and a plurality of nanofibers are grown subsequently, the nanofibers may fill the gaps between the nanowalls and thereby increase the coverage.

The growth process may require the deposition of additional layers on the substrate, such as help layers or growth catalyst layers. A growth catalyst layer comprises a material that is catalytically active and promotes the chemical reactions comprised in the formation of the grown nanostructures. A help layer may be used e.g. to control the properties of the grown nanostructures, facilitate vertically oriented growth, or otherwise improve the result of the growth process. Either the catalyst layer or the help layer, or both, may comprise materials such as nickel, iron, platinum, palladium, nickel-silicide, cobalt, molybdenum, or gold. Accordingly, the method may comprise depositing a growth catalyst layer on the conductive substrate 310 and growing the basal layer 321 and/or the plurality of nanostructures 322 on top of the growth catalyst layer.

A help layer or growth catalyst layer may be deposited using methods such as evaporating, plating, sputtering, molecular beam epitaxy, pulsed laser depositing, spin-coating, spray-coating, or other suitable methods. According to one example, the growth catalyst layer may comprise a uniform layer of growth catalyst material. According to another example, the growth catalyst layer may comprise a plurality of growth catalyst nanoparticles.

According to some aspects, a part of a help layer or catalyst layer may also be removed after growth of the nanostructures, e.g., by etching. The part of the help layer or catalyst layer that is removed may be a part extending between the grown nanostructures.

In some cases, the plurality of nanostructures 322 may comprise one type of nanostructures that is preferably grown with the aid of a growth catalyst, and another type of nanostructures that is preferably grown without a growth catalyst. In this case, the type of nanostructures requiring a growth catalyst may be grown first using a first set of growth parameters. The type of nanostructure not requiring a growth catalyst may then be grown using a second set of growth parameters.

According to some aspects, the method may also comprise depositing a protective coating on the separator element, where the protective coating is arranged to increase a resistance to corrosion. The protective coating may for example comprise any of titanium, titanium nitride, gold, and platinum.

According to one example, the basal layer 321 may comprise a carbon material such as graphene, graphite, diamond-like carbon, or amorphous carbon, while the plurality of nanostructures 322 comprises carbon nanowalls or vertical graphene. The plurality of nanostructures 322 may also comprise any of carbon nanofibers, carbon nanotubes, and carbon nanowires.

Advantageously, a coating comprising a basal layer 321 comprising a carbon material and a plurality of nanostructures 322 comprising vertical graphene may be grown using CVD in a single process step, optionally without the use of a growth catalyst, thereby lowering the cost of production compared to other coatings. A single process step is here taken to mean that the substrate does not need to be removed from the growth chamber or handled in between growing the basal layer 321 and the plurality of nanostructures 322, but that growth of both basal layer and nanostructures can be accomplished by adjusting the growth parameters of the CVD process.

There is herein also described a method for growing a basal layer comprising carbon and a plurality of carbon nanowalls on a substrate. The method comprises arranging a substrate, depositing a carbon basal layer on the substrate using chemical vapor deposition (CVD), and growing a plurality of carbon nanowalls on the substrate using CVD.

The substrate may be a conductive substrate comprising e.g. stainless steel or titanium, as described above. The substrate may also be any other suitable substrate, optionally comprising materials such as silicon, glass, ceramics, or silicon carbide.

In general, the CVD process comprises exposing the substrate to a precursor gas, which subsequently undergoes a reaction on the surface of the substrate to produce the desired structure. The formation of the structure is aided by factors such as the substrate temperature, the pressure in the growth chamber, the presence of inert carrier gases and/or reducing gases, and the presence of a growth catalyst. For growing carbon structures, the precursor gas may be a hydrocarbon gas such as acetylene or methane and the reducing gas may be hydrogen gas or ammonia. The carrier gas may for example be argon or nitrogen gas.

The carbon basal layer and the plurality of carbon nanowalls may be grown by CVD methods such as for example rapid thermal CVD, hot filament CVD, laser CVD or combustion CVD. Optionally, the carbon basal layer and the plurality of carbon nanowalls are grown by plasma-enhanced CVD, PECVD. PECVD further includes methods such as capacitively coupled plasma PECVD, inductively coupled plasma CVD, radio-frequency plasma PECVD, DC plasma CVD, and microwave plasma CVD.

During growth of the carbon basal layer, the substrate temperature is preferably chosen so as to allow the precursor gas to dissociate on the substrate. This promotes growth of the carbon basal layer. The exact temperature required will depend on the particular CVD method used and on the setting of other parameters such as pressure, plasma power, and plasma type. According to one example, the carbon basal layer could be grown using thermal CVD with a substrate temperature of between 500 and 1000° C. According to another example, the carbon basal layer could be grown using RF-CVD at a substrate temperature around 600° C. According to a third example, the carbon basal layer could be grown using hot filament CVD with a substrate temperature close to 1000° C.

Advantageously, once the carbon basal layer is grown, growth of the carbon nanowalls may be initiated by changing the growth conditions in the growth chamber. This may entail changing the CVD method used, e.g. from thermal to plasma-enhanced CVD. It may also entail changing the precursor gas, reducing gas, or inert filler gas, or adjusting the relative concentrations of the different gases. The temperature and pressure may also be changed. In the case of PECVD, the plasma power may be adjusted. The plasma type may also be changed, e.g. from DC plasma to RF plasma or vice versa.

According to one example, initiating growth of carbon nanowalls may entail changing the precursor gas from e.g. ethylene or acetylene to methane. According to another example, initiating growth of carbon nanowalls may entail switching the reducing gas to hydrogen instead of e.g. ammonia, or changing the inert filler gas to argon. According to a third example, initiating growth of carbon nanowalls may entail setting the temperature to above 700° C., or the pressure to between 1 and 10 mbar.

An advantage of a coating comprising a carbon basal layer and a plural carbon nanowalls is that both can be grown without the use of a growth catalyst. However, under some circumstances arranging the substrate may still comprise depositing a growth catalyst layer or a help layer. In particular, a growth catalyst layer may be used to grow another type of carbon nanostructure, such as carbon nanofibers or carbon nanotubes, in addition to the carbon nanowalls.

A growth catalyst layer comprises a material that is catalytically active and promotes the chemical reactions comprised in the formation of the grown nanostructures. A help layer may be used e.g. to control the properties of the grown nanostructures, facilitate vertically oriented growth, or otherwise improve the result of the growth process. Either the catalyst layer or the help layer, or both, may comprise materials such as nickel, iron, platinum, palladium, nickel-silicide, cobalt, molybdenum, or gold.

A help layer or growth catalyst layer may be deposited using methods such as evaporating, plating, sputtering, molecular beam epitaxy, pulsed laser depositing, spin-coating, spray-coating, or other suitable methods. According to one example, the growth catalyst layer may comprise a uniform layer of growth catalyst material. According to another example, the growth catalyst layer may comprise a plurality of growth catalyst nanoparticles.

1. A separator element for an electrochemical cell, the separator element comprising a conductive substrate and a coating applied to the conductive substrate, the coating comprising a first part and a second part, wherein the first part comprises a basal layer extending along a surface of the conductive substrate and the second part comprises a plurality of nanostructures extending out from the surface of the conductive substrate.

2. The separator element according to claim 1, wherein the basal layer comprises a carbon material.

3. The separator element according to claim 2, wherein the basal layer comprises any of graphene, graphite, and amorphous carbon.

4. The separator element according to claim 1, wherein the plurality of nanostructures comprises a plurality of carbon nanostructures.

5. The separator element according to claim 4, wherein the plurality of carbon nanostructures comprises at least one carbon nanowall.

6. The separator element according to claim 4, wherein the plurality of carbon nanostructures comprises any of a carbon nanotube, a carbon nanowire, and a carbon nanofiber.

7. The separator element according to claim 1, wherein the nanostructures comprised in the plurality of nanostructures extend in parallel to each other along a direction perpendicular to a plane of extension of the conductive substrate.

8. The separator element according to any claim 1, wherein the conductive substrate comprises a flow field arrangement, the flow field arrangement comprising a plurality of flow channels separated by a plurality of channel supports, wherein the flow channels are arranged to promote an even distribution of a gas and/or liquid over the conductive substrate.

9. The separator element according to claim 1, wherein the separator element is at least partly covered by a protective layer arranged to increase a resistance to corrosion.

10. The separator element according to claim 9, wherein the protective layer comprises any of titanium, gold, and platinum.

11. An electrolyzer comprising at least one separator element according to claim 1.

12. A fuel cell comprising at least one separator element according to claim 1.

13. A method for producing a separator element, the separator element comprising a conductive substrate and a coating applied to the conductive substrate, the method comprising:
arranging the conductive substrate,
depositing a first part of the coating onto the conductive substrate, the first part comprising a basal layer extending along a surface of the conductive substrate, and
depositing a second part of the coating onto the conductive substrate, the second part comprising a plurality of nanostructures extending out from the surface of the conductive substrate.

14. The method according to claim 13, wherein depositing the first part of the coating comprises growing the basal layer using chemical vapor deposition.

15. The method according to claim 14, wherein growing the basal layer using chemical vapor deposition comprises adjusting a growth parameter to achieve a desired layer thickness.

16. The method according to claim 15, wherein the growth parameter is any of a substrate temperature, a plasma power, a partial pressure of a precursor gas, and a total pressure in a growth chamber.

17. The method according to claim 13, wherein depositing the second part of the coating comprises growing the plurality of nanostructures on the basal layer using chemical vapor deposition.

18. The method according to claim 17, wherein growing the plurality of nanostructures using chemical vapor deposition comprises adjusting a growth parameter to achieve a desired nanostructure morphology.

19. The method according to claim 18, wherein the growth parameter is any of a substrate temperature, a plasma power, a partial pressure of a precursor gas, and a total pressure in a growth chamber.

20. The method according to claim 17, wherein growing the plurality of nanostructures using chemical vapor deposition comprises growing a plurality of nanostructures of different types, such as nanowalls, nanotubes, nanowires, or nanofibers.

21. The method according to claim 20, wherein growing a plurality of nanostructures of different types comprises adjusting a growth parameter to grow different nanostructure types.

22. The method according to claim 13, comprising depositing a growth catalyst layer on the conductive substrate and growing the basal layer and/or the plurality of nanostructures on top of the growth catalyst layer.
